(19) United States
(12) Patent Application Publication
(10) Pub. No.: US 2013/0079980 A1
(43) Pub. Date: Mar. 28, 2013

(54) TOWED VEHICLE ARRANGEMENT RESPONSIVE TO VEHICLE ACCELERATION AND DECELERATION

(71) Applicants: Carl T. Vuk, Denver, IA (US); Alan D. Sheidler, Moline, IL (US); Peter Finamore, Matthews, NC (US); Bernard E. Romig, Illinois City, IL (US)

(72) Inventors: Carl T. Vuk, Denver, IA (US); Alan D. Sheidler, Moline, IL (US); Peter Finamore, Matthews, NC (US); Bernard E. Romig, Illinois City, IL (US)

(21) Appl. No.: 13/242,381

(22) Filed: Sep. 23, 2011

(51) Int. Cl. B62D 59/04

(52) U.S. Cl. 701/36

(57) ABSTRACT

A vehicle arrangement includes a tow vehicle and a towed vehicle. The towed vehicle includes at least two wheels and at least one motor, with each motor being coupled with a corresponding wheel. A load sensing hitch between the tow vehicle and the towed vehicle provides an output signal representing a sensed load on the load sensing hitch. An electrical processing circuit is coupled with the load sensing hitch. The electrical processing circuit actuates at least one motor, dependent upon the output signal.

### FIELD OF THE INVENTION

The present invention relates to arrangements for towing a towed vehicle behind a tow vehicle, and, more particularly, to arrangements for towing a towed implement behind a work vehicle.

### BACKGROUND OF THE INVENTION

When using agricultural equipment, it is common to pull a towed vehicle behind a tow vehicle. For example, during a harvesting operation, it is common to pull a grain cart or gravity box behind a tractor. When the grain bin in the combine is full, the grain cart or gravity box is pulled along side of the combine, the unloading auger is swung to the side of the combine, and the grain is offloaded into the cart or gravity box. The full cart or gravity box may then be transported to a dryer location, such as an on-farm batch or bin dryer, or a local elevator.

As another example, it is also common to pull a fertilizer spreader behind a tractor for application of fertilizer, lime, etc. to an agricultural field.

When pulling a towed vehicle such as an agricultural cart, wagon, spreader or the like behind a tractor, the weight of the towed vehicle when full with product can be substantial. For this reason, it is common to use a relatively large tractor to pull such a towed vehicle. The weight effects of a towed vehicle on a tow vehicle are further compounded when a number of towed vehicles are connected together in a train arrangement, such as a number of loaded gravity boxes which are trained together and pulled to a dryer location using a single tractor.

What is needed in the art is a way of towing a heavy towed vehicle or train of towed vehicles, without adversely affecting the operation of the tow vehicle.

### SUMMARY

The present invention provides a towed vehicle arrangement in which one or more wheels on the towed vehicle are driven and/or braked in response to a sensed parameter associated with an acceleration or deceleration of the towed vehicle.

The invention in one form is directed to a vehicle arrangement, including a tow vehicle and a towed vehicle. The towed vehicle includes at least two wheels and at least one motor, with each motor being coupled with a corresponding wheel. A load sensing hitch between the tow vehicle and the towed vehicle provides an output signal representing a sensed load on the load sensing hitch. An electrical processing circuit is coupled with the load sensing hitch. The electrical processing circuit actuates at least one motor, dependent upon the output signal.

The invention in another form is directed to a towed vehicle arrangement, including a frame, at least two wheels carried by the frame, at least one motor, and an electrical processing circuit. Each motor is coupled with a corresponding wheel. A sensor arrangement senses a parameter associated with an acceleration or deceleration of the towed vehicle, and provides a corresponding output signal. The electrical processing circuit is coupled with the sensor arrangement. The electrical processing circuit actuates at least one motor, dependent upon the output signal.

The invention in yet another form is directed to a method of towing a towed vehicle using a tow vehicle. The towed vehicle has at least one motor with each motor being coupled with a corresponding wheel. The method includes the steps of: sensing a parameter associated with an acceleration or deceleration of the towed vehicle using a sensor arrangement; outputting an output signal from the sensor arrangement representing the sensed parameter; and actuating at least one motor using an electrical processing circuit, dependent upon the output signal.

### BRIEF DESCRIPTION OF THE DRAWINGS

The above-mentioned and other features and advantages of this invention, and the manner of attaining them, will become more apparent and the invention will be better understood by reference to the following description of embodiment of the invention taken in conjunction with the accompanying drawings, wherein:

FIG. 1 is a perspective view of an embodiment of a towed vehicle of the present invention in the form of a fertilizer spreader;

FIG. 2 is a schematic view of the fertilizer spreader shown in FIG. 1; and

FIG. 3 is a flowchart illustrating an embodiment of a method of the present invention for towing a towed vehicle.

Corresponding reference characters indicate corresponding parts throughout the several views. The exemplification set out herein illustrates an embodiment of the invention, in one form, and such exemplification is not to be construed as limiting the scope of the invention in any manner.

### DETAILED DESCRIPTION

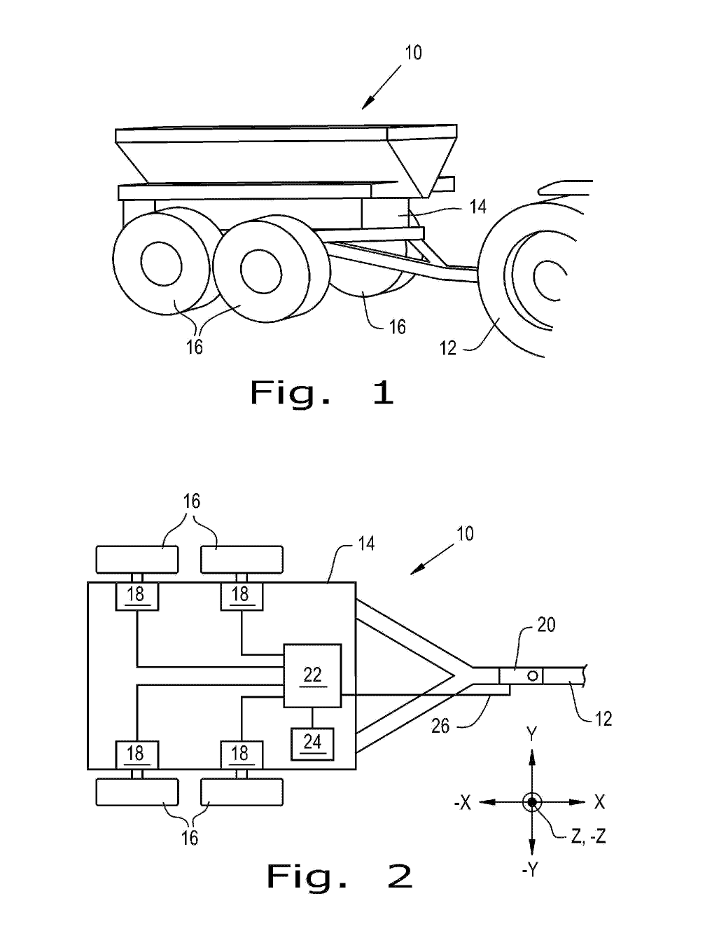

Referring now to the drawings, and more particularly to FIG. 1, there is shown an embodiment of a vehicle arrangement of the present invention including a towed vehicle 10 which is towed by a tow vehicle 12. Towed vehicle 10 is shown in the form of a fertilizer spreader in the illustrated embodiment, but could be any type of other towed vehicle. For example, towed vehicle 10 could also be in the form of a grain cart, a gravity box, and air cart, etc.

Towed vehicle 10 (FIGS. 1 and 2) generally includes a frame 14, at least two wheels 16 carried by frame 14, at least one motor 18, a sensor arrangement 20, and an electrical processing circuit 22. In the illustrated embodiment, towed vehicle 10 includes four wheels 16, but may include a different number of wheels, depending on the application.

Towed vehicle 10 is shown as including four motors 18 which are respectively coupled with a corresponding wheel 16. However, towed vehicle 10 need not necessarily include a motor 18 associated with each corresponding wheel 16. For example, towed vehicle 10 could be provided with a pair of motors 18 with a single motor on each side. Motors 18 are assumed to be electric motors in the illustrated embodiment, but could be differently configured depending on the application, such as hydraulic motors.

When configured as electric motors, it is desirable to provide towed vehicle 10 with an onboard source of electrical power, such as a single battery 24 or a bank of batteries. The electrical power could also be obtained from an onboard internal combustion engine (i.e., the alternator/generator output of such an engine). Alternatively, it is also possible to obtain electrical power from a similar electrical source onboard tow vehicle 12.

Sensor arrangement 20 senses a parameter associated with an acceleration or deceleration of towed vehicle 10 along a selected one of a plurality of axes. For example, as shown in FIG. 2, sensor arrangement 20 may be configured to sense a parameter associated with an acceleration or deceleration along 3 separate axes defining a 3-D coordinate system. In the illustrated example, sensor arrangement 20 may be provided with load cells or accelerometers to sense a parameter along the plus or minus X, Y and/or Z directions (the Z direction extending perpendicular to the drawing plane of FIG. 2). Of course, sensed parameters in the X, Y and Z directions may be used to calculate the magnitude and directional vector of the sensed parameter in the 3-D coordinate system. A parameter sensed in the X direction may be used, e.g., to sense acceleration or deceleration of towed vehicle 10, and in turn apply an acceleration or braking torque using selected motor(s) 18. A parameter sensed in the Y direction may be used, e.g., to sense a turning maneuver or wheel dropping into a hole, and in turn apply an acceleration or braking torque to achieve a torque vectoring of towed vehicle 10. A parameter sensed in the Z direction may be used, e.g., to sense an upward or downward travel or torque of towed vehicle 10, and in turn apply a driving or braking torque using selected motor(s) 18, or an active suspension system control technique to shift weight between wheels 16.

In the embodiment shown, sensor arrangement 20 is shown as including a load sensing hitch for sensing fore and aft loading thereon as towed vehicle 10 accelerates or decelerates. For example, towed vehicle 10 may accelerate when an operator increases the throttle or up shifts on-the-fly. Moreover, towed vehicle 10 may decelerate when an operator decreases the throttle or downshifts on-the-fly, or when a wheel 16 drops into a depression or hole in a field.

The specific configuration of sensor arrangement 20 in the form of a load sensing hitch may vary, depending on the application. For example, sensor arrangement 20 may include one or more load cells for detecting fore and aft loading during acceleration and deceleration. Moreover, sensor arrangement 20 is shown as being coupled with and carried by a portion of the tongue or hitch of towed vehicle 10, but could also be carried by the hitch extending rearward from tow implement 12, or even potentially partially carried by each of towed vehicle 10 and tow vehicle 12. Other configurations are also possible.

Electrical processing circuit 22 receives an output signal from sensor arrangement 20 and actuates one or more motors 18, dependent upon the output signal. Electrical processing circuit 22 is shown as being connected with sensor arrangement 20 via a single line 26, but could be coupled in a different manner such as a data bus, wireless connection, etc.

More specifically, the electrical processing circuit 22 compares a value of the output signal from sensor arrangement 20 representing fore and aft loading with an acceptable load range corresponding to a range of tension and compression loading on sensor arrangement 20. If the value of the output signal falls within this acceptable load range, then none of the motors 18 are actuated. On the other hand, if the value of the output signal falls outside of this acceptable load range, then one or more motors 18 are actuated to apply a desired thrust or braking action to the corresponding wheel. In this manner, towed vehicle 10 is independently accelerated or decelerated apart from any pulling force applied by tow vehicle 12.

Electrical processing circuit 22 actuates one or more motors 18 such that an amount of thrust or braking that is applied to a corresponding motor 18 is proportional to a weight of material which is carried by towed vehicle 10 (which in turn can also correspond to the overall weight of towed vehicle 10). For example, in the case of a grain cart or gravity box, the weight thereof increases from an empty weight to a full weight during filling of a grain product. Conversely, in the case of a fertilizer spreader, the weight thereof decreases from a full weight to an empty weight during application of the material.

It is also possible to limit the torque which is applied to a motor 18 such that damage does not occur to the chassis, drive train, etc. For example, electrical processing circuit 22 may be configured to apply a command signal effecting a maximum torque to a given motor 18 and wheel 16 which is less than a maximum threshold amount. Furthermore, it may be possible to simply limit the maximum output torque of a given motor 18 so that the maximum torque is below a threshold value.

In the embodiment illustrated and described above, the sensor arrangement 20 is in the form of a load sensing hitch which senses fore and aft loading which occurs during acceleration and deceleration of towed vehicle 10. It is also possible to use other sensor and control arrangements which sense or detect a parameter associated with an acceleration or deceleration of towed vehicle 10. For example, it may be possible to equip towed vehicle 10 with an accelerometer for detecting acceleration or deceleration, and then actuate one or more motors 18 to effect a desired thrust or braking action. Moreover, it may be possible to use a brake control which is actuated when an operator depresses a brake pedal onboard tow vehicle 12, dependent on the amount that the brake pedal is depressed. Conversely, it may be possible to apply a thrust action to a given motor 18 when an operator actuates an accelerator control or a throttle control onboard tow vehicle 12.

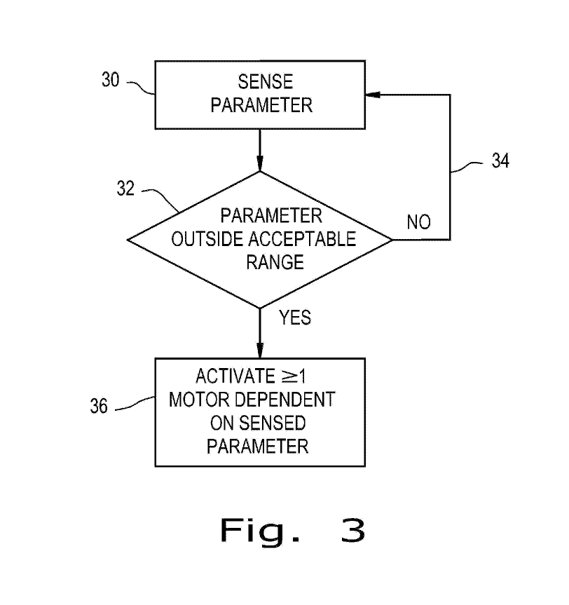

Referring now to FIG. 3, there is shown a simplified illustration of a method of towing a towed vehicle of the present invention. At box 30, a parameter is sensed which corresponds to an acceleration or deceleration of towed vehicle 10. In the embodiment shown in FIGS. 1 and 2, the sensed parameter corresponds to fore and aft (compression and tension) loading on a load sensing hitch. In other embodiments as described above, the sensed parameter can correspond to an output signal from an accelerometer, a brake pedal, and accelerator control and/or a throttle control. If the output signal for the sensed parameter falls within a given acceptable range, then tow vehicle 12 simply continues to pull the towed vehicle 10 without assistance from motors 18 (block 32 and line 34). On the other hand, if the output signal for the sensed parameter falls outside of a given acceptable range, then electrical processing circuit 22 actuates one or more electric motors 18 to apply a thrust or braking action to a corresponding wheel 16, as desired and appropriate (block 36).

The present invention has an advantage in that a large tow vehicle 12 is no longer needed to pull or tow a heavy towed vehicle 10. This allows the size of the tow vehicle 12 to be decreased, which in turn decreases the cost of the required vehicle as well as associated operating costs like fuel, etc. The towed vehicles 10 can even be coupled together in a train arrangement while still allowing the use of a relatively small tow vehicle 12.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A vehicle arrangement, comprising:
a tow vehicle;
a towed vehicle including at least two wheels and at least one motor, each said motor being coupled with a corresponding said wheel;
a load sensing hitch between said tow vehicle and said towed vehicle, said load sensing hitch sensing a load along at least one of a plurality of axes, said load sensing hitch providing an output signal representing a sensed load on said load sensing hitch; and
an electrical processing circuit coupled with said load sensing hitch, said electrical processing circuit actuating at least one said motor, dependent upon said output signal.

2. The vehicle arrangement of claim 1, wherein said towed vehicle includes said load sensing hitch.

3. The vehicle arrangement of claim 1, wherein said load sensing hitch senses fore and aft loading thereon.

4. The vehicle arrangement of claim 3, wherein said electrical processing circuit compares a value of said fore and aft loading with an acceptable load range, and actuates at least one said motor if said value is outside of said acceptable load range.

5. The vehicle arrangement of claim 4, wherein said acceptable load range corresponds to a range of tension and compression loading on said load sensing hitch.

6. The vehicle arrangement of claim 1, wherein said electrical processing circuit actuates at least one said motor to provide one of thrust and braking to a corresponding said wheel.

7. The vehicle arrangement of claim 6, wherein an amount of thrust or braking that said at least one motor applies to a corresponding said wheel is proportional to a weight of material carried by said towed vehicle.

8. The vehicle arrangement of claim 6, wherein one of said electrical processing circuit and said at least one motor includes a torque limiter for limiting an amount of said thrust or braking that is applied to said at least one motor.

9. The vehicle arrangement of claim 1, wherein said motor is an electric motor.

10. The vehicle arrangement of claim 9, including an electrical power source for providing electrical power to said at least one motor.

11. The vehicle arrangement of claim 10, wherein said electrical power source includes one of a) at least one battery, and b) an internal combustion engine.

12. The vehicle arrangement of claim 1, wherein said towed vehicle is a towed implement.

13. A towed vehicle arrangement, comprising:
a frame;
at least two wheels carried by said frame;
at least one motor, each said motor being coupled with a corresponding said wheel;
a sensor arrangement for sensing a parameter associated with an acceleration or deceleration of said towed vehicle along a selected one of a plurality of axes, said sensor arrangement providing an output signal; and
an electrical processing circuit coupled with said sensor arrangement, said electrical processing circuit actuating at least one said motor, dependent upon said output signal.

14. The towed vehicle arrangement of claim 13, wherein said sensor arrangement includes a load sensing hitch on said towed vehicle, and said output signal represents a sensed load on said load sensing hitch.

15. The towed vehicle arrangement of claim 14, wherein said load sensing hitch senses fore and aft loading thereon.

16. The towed vehicle arrangement of claim 15, wherein said electrical processing circuit compares a value of said fore and aft loading with an acceptable load range, and actuates at least one said motor if said value is outside of said acceptable load range.

17. The towed vehicle arrangement of claim 16, wherein said acceptable load range corresponds to a range of tension and compression loading on said load sensing hitch.

18. The towed vehicle arrangement of claim 13, wherein said electrical processing circuit actuates at least one said motor to provide one of thrust and braking to a corresponding said wheel.

19. The towed vehicle arrangement of claim 18, wherein an amount of thrust or braking that said at least one motor applies to a corresponding said wheel is proportional to a weight of material carried by said towed vehicle.

20. The towed vehicle arrangement of claim 18, wherein one of said electrical processing circuit and said at least one motor includes a torque limiter for limiting an amount of said thrust or braking that is applied to said at least one motor.

21. The towed vehicle arrangement of claim 13, wherein said sensor arrangement includes one of:
a) a load sensing hitch;
b) a brake control and accelerator control;
c) a brake control and throttle control; and
d) an accelerometer.

22. The towed vehicle arrangement of claim 21, including an electrical power source for providing electrical power to said at least one motor.

23. The towed vehicle arrangement of claim 22, wherein said electrical power source includes one of a) at least one battery, and b) an internal combustion engine.

24. The towed vehicle arrangement of claim 13, wherein said towed vehicle is a towed implement.

25. A method of towing a towed vehicle using a tow vehicle, the towed vehicle having at least one motor with each motor being coupled with a corresponding wheel, said method comprising the steps of:
sensing a parameter using a sensor arrangement which is associated with an acceleration or deceleration of said towed vehicle along a selected one of a plurality of axes;
outputting an output signal from said sensor arrangement representing said sensed parameter; and
actuating at least one said motor using an electrical processing circuit, dependent upon said output signal.

26. The method of claim 25, wherein said sensing step comprises sensing a fore and aft loading on a load sensing hitch.

27. The method of claim 26, wherein said sensed loading is compared with an acceptable load range on said hitch assembly, and said actuating step is carried out if said sensed loading is outside of said acceptable load range.

28. The method of claim 27, wherein said acceptable load range corresponds to a range of tension and compression loading on said hitch assembly.

29. The method of claim 26, wherein said actuating step comprises actuating at least one said motor, dependent upon said sensed fore and aft loading of said hitch assembly.

30. The method of claim 25, wherein said actuating step is carried out such that said at least one motor provides one of thrust or braking to a corresponding said wheel.

31. The method of claim 30, wherein an amount of thrust or braking that said at least one motor applies to a corresponding said wheel is proportional to a weight of material carried by said towed vehicle.

32. The method of claim 30, wherein one of said electrical processing circuit and said at least one motor includes a torque limiter for limiting an amount of said thrust or braking that is applied to said at least one motor.

33. The method of claim 25, wherein said sensor arrangement includes one of:
a) a load sensing hitch;
b) a brake control and accelerator control;
c) a brake control and throttle control; and
d) an accelerometer.

34. The method of claim 25, wherein said motor is an electric motor.

35. The method of claim 25, wherein said towed vehicle is a towed implement.
